(19) United States
(12) Patent Application Publication
(10) Pub. No.: US 2023/0166610 A1
(43) Pub. Date: Jun. 1, 2023

(54) CHARGING SYSTEM, SAFETY MANAGEMENT PROGRAM FOR CHARGING SYSTEM AND SAFETY MANAGEMENT METHOD FOR CHARGING SYSTEM

(71) Applicant: TOYOTA JIDOSHA KABUSHIKI KAISHA, Toyota-shi (JP)

(72) Inventors: Masaaki SATO, Susono-shi (JP); Satoshi KONDO, Numazu-shi (JP)

(73) Assignee: TOYOTA JIDOSHA KABUSHIKI KAISHA, Toyota-shi (JP)

(21) Appl. No.: 17/987,919

(22) Filed: Nov. 16, 2022

(30) Foreign Application Priority Data
Nov. 29, 2021 (JP) 2021-193372

(51) Int. Cl. B60L 53/18; B60L 53/65; B60L 53/66; B60L 53/35; B60L 53/31

(52) U.S. Cl. CPC B60L 53/18; B60L 53/65; B60L 53/66; B60L 53/35; B60L 53/31

(57) ABSTRACT

A charging system of the present disclosure includes: an arm mechanism—configured to grasp a charging plug connected to a charging apparatus through a charging cable and automatically perform plugging/unplugging of the charging plug to and from a charge port of a vehicle located at a charging area; a sensor configured to detect whether or not a state of the charging cable meets predetermined safety conditions when the charging plug is inserted into the charge port of the vehicle; and a control unit configured to perform at least one of a process of making the arm mechanism operate to move the charging cable so that the state of the charging cable becomes one in which the predetermined safety conditions are met or a process of updating the predetermined safety conditions based on the state of the charging cable.

### CROSS REFERENCE TO RELATED APPLICATIONS

This application is based upon and claims the benefit of priority from Japanese patent application No. 2021-193372, filed on Nov. 29, 2021, the disclosure of which is incorporated herein in its entirety by reference.

### BACKGROUND

The present disclosure relates to a charging system, a safety management program for a charging system, and a safety management method for a charging system such as a charging system including an arm mechanism for automatically inserting and removing a charging plug from a charge port (i.e. socket) of a vehicle, a safety management program for the charging system, and a safety management program for the charging system.

In recent years, battery electric vehicles (BEV) including plug-in hybrid electric vehicles (HEV) have become widespread. Further, self-driving technique for vehicles have been improving. Under such circumstances, a system of valet parking has been proposed in which a vehicle, which is parked in a parking space at a location different from the location where a person who is a to-be-occupant of the vehicle gets into the vehicle, travels autonomously without any human driver on board between the parking space and the location where the to-be-occupant of the vehicle gets into the vehicle. In this case, the battery electric vehicle needs to be charged at the parking space, and a method of charging the battery electric vehicle at the parking space has been proposed. An example of the aforementioned technique is disclosed in Japanese Unexamined Patent Application Publication No. 2020-102220.

An automated valet parking system described in Japanese Unexamined Patent Application Publication No. 2020-102220 includes steps of: activating an automated valet parking procedure; determining whether charging of an electric vehicle is needed or not; setting a parking space for wireless charging service as a first target position when charging of the electric vehicle is needed; transmitting, by an infrastructure, the first target position and a guide route to the electric vehicle; setting an empty parking space as a second target position after the charging of the electric vehicle is completed; and transmitting the second target position and the guide route to the electric vehicle.

### SUMMARY

When an arm mechanism inserts a charging plug into a charge port of a vehicle, a charging cable may interfere with parking sections adjacent to the parking section in which the aforementioned vehicle having the charging plug inserted in its charge port is parked depending on the position of the charging plug of the vehicle. In the technique disclosed in Japanese Unexamined Patent Application Publication No. 2020-102220, there are safety issues caused by charging cables, and a satisfactory safety level in using charging cables cannot be ensured.

The present disclosure has been made to solve the problem mentioned above and an object of the present disclosure is to eliminate safety issues caused by charging cables and ensure safety in using charging cables at a satisfactory level.

A first exemplary aspect is a charging system including:

an arm mechanism configured to grasp a charging plug connected to a charging apparatus through a charging cable and automatically perform plugging/unplugging of the charging plug to and from a charge port of a vehicle located at a charging area;

a sensor configured to detect whether or not a state of the charging cable meets predetermined safety conditions when the charging plug is inserted into the charge port of the vehicle; and

a control unit configured to perform, in the case where it is detected that the charging cable is in a state in which it does not meet the predetermined safety conditions, at least one of a process of making the arm mechanism operate to move the charging cable so that the state of the charging cable becomes one in which the predetermined safety conditions are met or a process of updating the predetermined safety conditions based on the state of the charging cable.

A further another exemplary aspect is a safety management program for a charging system, which comprises an arm mechanism configured to grasp a charging plug connected to a charging apparatus through a charging cable and automatically perform plugging/unplugging of the charging plug to and from a charge port of a vehicle located at a charging area, to perform:

a process of detecting, using information obtained from a sensor connected to the charging system, whether or not a state of the charging cable meets predetermined safety conditions when the charging plug is inserted into the charge port of the vehicle; and

in the case where it is detected that the state of the charging cable does not meet the predetermined safety conditions, at least one of a process of making the arm mechanism operate to move the charging cable so that the state of the charging cable becomes one in which the predetermined safety conditions are met or a process of updating the predetermined safety conditions based on the state of the charging cable.

A further another exemplary aspect is a safety management method for a charging system that comprises an arm mechanism configured to grasp a charging plug connected to a charging apparatus through a charging cable and automatically perform plugging/unplugging of the charging plug to and from a charge port of a vehicle located at a charging area, the method comprising:

detecting, using information obtained from a sensor connected to the charging system, whether or not a state of the charging cable meets predetermined safety conditions when the charging plug is inserted into the charge port of the vehicle; and

performing, in the case where it is detected that the state of the charging cable does not meet the predetermined safety conditions, at least one of a process of making the arm mechanism operate to move the charging cable so that the state of the charging cable becomes one in which the predetermined safety conditions are met or a process of updating the predetermined safety conditions based on the state of the charging cable.

A charging system, a safety management program for a charging system, and a safety program for a charging system according to the present disclosure are each adapted to determine whether or not the state of a charging cable meets safety conditions and perform processes for controlling a vehicle under a state in which the state of the charging cable meets the safety conditions.

According to the present disclosure, a charging system can be provided in which safety issues caused by charging cables are eliminated and safety in using charging cables can be ensured at a satisfactory level.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a block diagram of a charging system according to a first embodiment;

FIG. 2 is a schematic diagram of parking areas in the charging system according to the first embodiment;

FIG. 3 is a diagram for explaining an example of a state in which a state of a charging cable does not meet the safety conditions in a charging area of the charging system according to the first embodiment;

FIG. 4 is a flowchart for explaining operations of the charging system according to the first embodiment;

FIG. 5 is a flowchart for explaining safe area updating process of the charging system according to the first embodiment;

FIG. 6 is a diagram for explaining an example of a state in which a state of a charging cable does not meet the safety conditions in the charging area of a charging system according to a second embodiment;

FIG. 7 is a flowchart for explaining safe area updating process of the charging system according to the second embodiment; and

FIG. 8 is a flowchart for explaining safe area updating process of a charging system according to a third embodiment.

### DESCRIPTION OF EMBODIMENTS

The same or corresponding elements are denoted by the same reference numerals (or symbols) throughout the drawings, and redundant descriptions thereof are omitted as required for clarifying the explanation. Further, each of the elements shown in the drawings as function blocks indicating various processes can be configured of a CPU (Central Processing Unit), a memory, and other circuits in terms of a hardware configuration, and can be implemented by programs loaded in a memory or the like in terms of a software configuration. Therefore, a skilled person in the art can understand that these function blocks can be realized in various forms such as a hardware configuration alone, a software configuration alone, or a combination thereof, and are not limited to any one of them. Note that the same or corresponding elements are denoted by the same reference numerals (or symbols) throughout the drawings, and redundant descriptions thereof are omitted as required.

The above-described program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

### First Embodiment

In a charging system described below, a charging plug provided at the tip of a charging cable is inserted into a charge port of a vehicle such as a battery electric vehicle using an arm mechanism, and the battery electric vehicle is charged accordingly. Here, in the charging system, a vehicle to be charged includes not only a vehicle which a person who is a to-be-occupant of the vehicle can get into but also includes a vehicle that can travel autonomously without any human driver on board. Further, in a parking area which is a region to be managed by the charging system, vehicles travel by following instructions from the charging system.

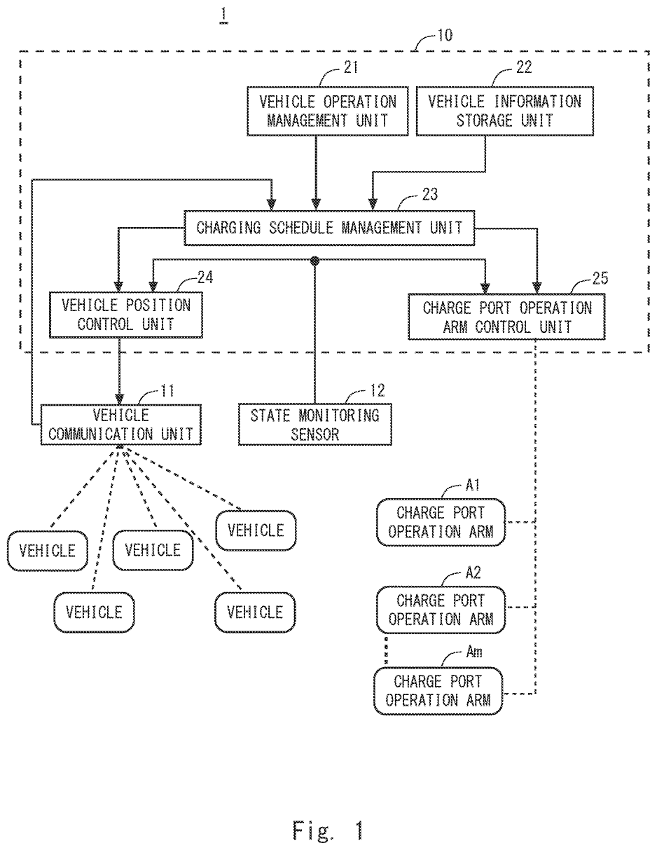

FIG. 1 shows a block diagram of a charging system 1 according to a first embodiment. Note that parking areas that are managed by the charging system are omitted in FIG. 1. As shown in FIG. 1, the charging system 1 according to the first embodiment includes a management apparatus 10, a vehicle communication unit 11, and a state monitoring sensor 12. Further, in FIG. 1, vehicles-to-be-monitored by the charging system 1 and an arm mechanism (e.g. charge port operation arms A1 to Am (m is an integer indicating the number of the charge port operation arms)) to be controlled by the charging system 1 are shown. It is to be noted that the number of the vehicles to be managed by the charging system 1 may be one, and there is no need to manage a plurality of vehicles.

First, the charging system 1 includes an arm mechanism (e.g. the charge port operation arms A1 to Am) for grasping a charging plug connected to a charging apparatus through a charging cable and automatically performing plugging/unplugging of the charging plug to and from a charge port of a vehicle located at a charging area. Then, the charging system 1 detects, using a sensor (e.g. the state monitoring sensor 12), whether or not the state of the charging cable meets the predetermined safety conditions when the charging plug is inserted into the charge port of the vehicle. Further, when the state of the charging cable detected using the state monitoring sensor 12 is a state in which the state of the charging cable does not meet the predetermined safety conditions, the charging system 1 performs, using a control unit (e.g. the management apparatus 10), at least one of a process of making at least one of the charge port operation arms A1 to Am operate to move the charging cable so that the state of the charging cable becomes one in which the safety conditions are met or a process of updating the predetermined safety conditions based on the state of the charging cable. Further, the charging system 1 have the management apparatus 10 perform communication with a vehicle using the vehicle communication unit 11 and provides a traveling route to the vehicle and instructs the vehicle to travel along the traveling route.

The vehicle communication unit 11 controls communication performed between the management apparatus 10 and the vehicle based on the prescribed communication protocols. The state monitoring sensor 12 can be realized by, for example, a camera that captures an image of a parking area, a weight sensor embedded in a parking area, a sensor capable of identifying the state of a vehicle and a charging cable in a parking area using radio signals or the like, and so on. In the following description, an example in which a camera is employed as the state monitoring sensor 12 will be explained, but the form of the state monitoring sensor 12 is not limited to cameras.

The process blocks shown in the management apparatus 10, which is shown in FIG. 1, can be implemented by an exclusive hardware or by executing programs in an operation unit of an operation device such as a computer. Further, as regards a storage unit among the process blocks shown in the management apparatus 10, it can be realized by a storage apparatus that is accessible by a computer.

The management apparatus 10 includes a vehicle operation management unit 21, a vehicle information storage unit 22, a charging schedule management unit 23, a vehicle position control unit 24, and a charge port operation arm control unit 25. The vehicle operation management unit 21 manages exit/entry of a vehicle out of/into a parking area in accordance with a request from a user of the vehicle. Further, the vehicle operation management unit 21 performs communication with a vehicle using another communication channel (not shown) and determines the operation schedule of the vehicle, the traveling distance of the vehicle, and the state of charge of the vehicle. The vehicle information storage unit 22 is a database for holding specifications by vehicle types such as the position of a charge port, the standards of the charge port, the full-charge capacity of the vehicle, and the like.

The charging schedule management unit 23 generates a charging schedule for efficiently performing charging of a vehicle to be managed based on the state of the vehicle, the operation schedule and the specifications of the vehicle obtained from the vehicle operation management unit 21 and the vehicle information storage unit 22.

Based on the charging schedule generated by the charging schedule management unit 23, the vehicle position control unit 24 designates a parking position for a vehicle that has entered a parking area, changes the parking position to that for charging, and instructs the vehicle to travel. The charge port operation arm control unit 25 instructs the charge port operation arms A1 to Am to select the charging cable according to the charging schedule generated by the charging schedule management unit 23 and to perform operation of inserting the charging plug into the insertion port of the vehicle.

Further, the vehicle position control unit 24 and the charge port operation arm control unit 25 determine whether or not the current state of the charging cable obtained from the state monitoring sensor 12 is a state in which it meets the predetermined safety conditions based on the state of the parking area obtained from the state monitoring sensor 12. When the current state of the charging cable obtained from the state monitoring sensor 12 is a state in which the state of charging cable does not meet the predetermined safety conditions, processes for making the state of the charging cable meet the predetermined safety conditions are performed. For example, when making the state of the charging cable meet the predetermined safety conditions by the vehicle position control unit 24, the vehicle position control unit 24 performs a process of updating the predetermined safety conditions based on the state of the charging cable. Further, when making the state of the charging cable meet the safety conditions by the charge port operation arm control unit 25, the charge port operation arm control unit 25 performs a process of making the arm mechanism operate to move the charging cable so that the state of the charging cable becomes one in which the safety conditions are met. In the charging system 1, processes of for making the state of the charging cable meet the safety conditions are performed by at least one of the vehicle position control unit 24 and the charge port operation arm control unit 25.

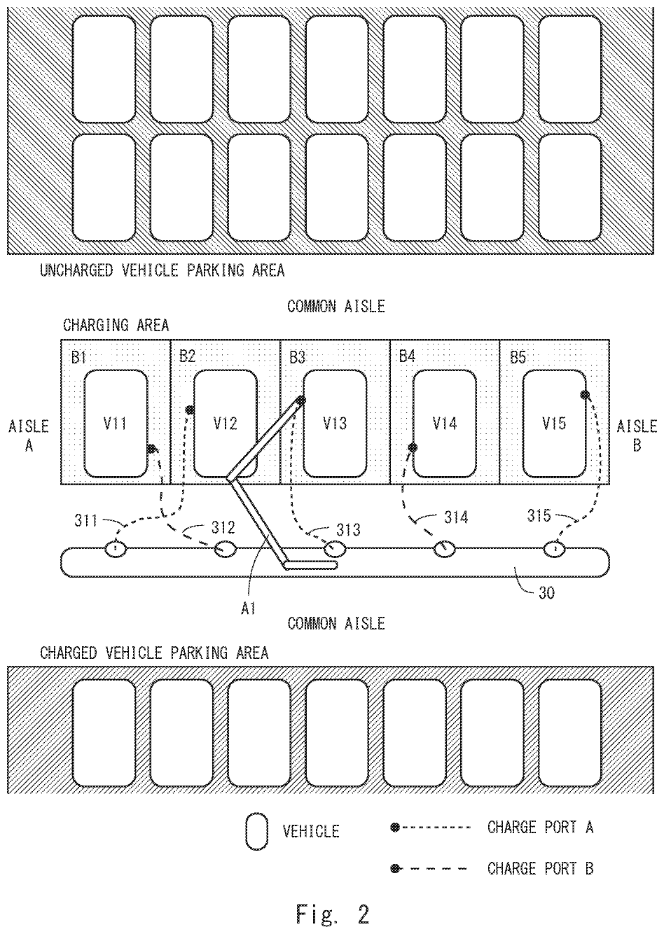

Here, a configuration of parking areas of the charging system 1 according to the first embodiment will be described. FIG. 2 shows a schematic diagram of the parking areas in the charging system according to the first embodiment. As shown in FIG. 2, a charging apparatus 30 is disposed in the parking area. A charging area corresponding to the charging apparatus 30 is provided. Further, in the example shown in FIG. 2, a plurality of (five in FIG. 2) charging sections B1 to B5 for charging are provided in the charging area. The example shown in FIG. 2 shows a state in which vehicles V11 to V15 are respectively parked in the parking sections B1 to B5 for charging.

Further, the parking areas managed by the charging system 1 include an uncharged vehicle parking area for parking vehicles that are not yet charged and a charged vehicle parking area for parking vehicles that have been charged and are on standby. A vehicle that has entered the parking area is parked in the uncharged vehicle parking area and a vehicle that has been charged is parked in the charged vehicle parking area where it waits to exit the parking area.

Further, in the example shown in FIG. 2, the charging apparatus 30 has charging cables that are compatible with the standards of two types of charge ports.

In the example shown in FIG. 2, the charging cables 311, 313, and 315 are charging cables to each of which a charging plug compatible with the charge port standard A is provided. Further, the charging cables 312 and 314 are charging cables to each of which a charging plug compatible with the charge port standard B is provided. Further, the charge port operation arm A1 is attached to the charging apparatus 30. In FIG. 2, one charge port operation arm that corresponds to the charging area is shown, but a plurality of charge port operation arms may be disposed.

The charging system 1 makes the vehicle parked in the uncharged vehicle parking area travel to the parking section for charging in the charging area and makes the vehicle for which charging has been completed travel to the charged vehicle parking area by using an aisle A or an aisle B on either side of the charging area as a route thereof. Then, the charging system 1 according to the first embodiment determines whether or not the state of the charging cable meets the predetermined safety conditions when the vehicles are made to travel and sets only the area in which the state of the charging cable meets the safety conditions as an area through which a route of the vehicles passes or an area where the vehicles can be parked.

Next, how the charging system 1 according to the first embodiment operates will be described. In the first embodiment, among the processes of making the charging cable meet the safety conditions performed by the charging system 1, a process of making the arm mechanism (e.g. the charge port operation arm A1) operate to move the charging cable so that the state of the charging cable becomes one in which the updated predetermined safety conditions are met will be described.

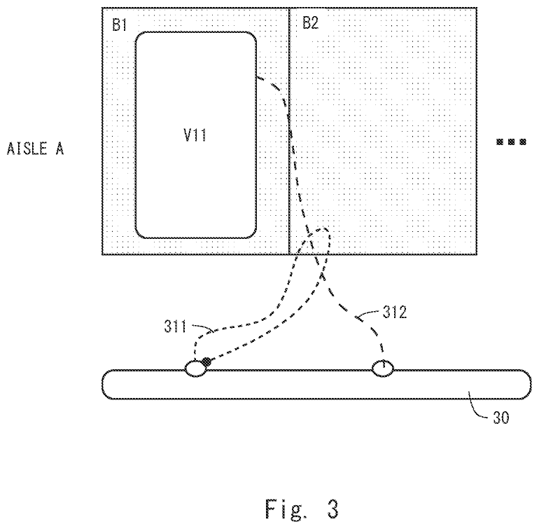

Firstly, the state in which the safety conditions are not met, which is a case covered in the first embodiment, will be described. FIG. 3 shows a diagram for explaining an example of a state in which a state of a charging cable does not meet the safety conditions in the parking area of the charging system according to the first embodiment.

The example shown in FIG. 3 shows a state in which charging of the vehicle V12 parked in the parking section B2 for charging has been completed and the vehicle V12 is made to travel from the parking section B2 for charging, whereby the parking section B2 for charging is in a vacant state (i.e. nothing is parked in the parking section B2 for charging). In the example shown in FIG. 3, a state is shown in which a part of the charging cable 311 has not been removed from inside the parking section B2 for charging in the aforementioned state. Further, in the example shown in FIG. 3, a part of the charging cable 312 connected to the vehicle V11 has not been removed from inside the parking section B2 for charging. In this state, when a new vehicle (i.e. a next incoming vehicle) is parked in the parking section B2 for charging, there is a risk of the part of the charging cable 312 that is connected to the vehicle V11 that has not been removed from inside the parking section B2 for charging getting tangled with the next incoming vehicle or being driven over by the next incoming vehicle. Therefore, in the charging system 1 according to the first embodiment, it is detected that the state of the charging cable does not meet the safety conditions using the state monitoring sensor 12 and the charge port operation arm control unit 25, and the charge port operation arm A1 is operated by the charge port operation arm control unit 25, whereby the state in which a part of the charging cable has not been removed from inside the parking section B2 for charging is corrected.

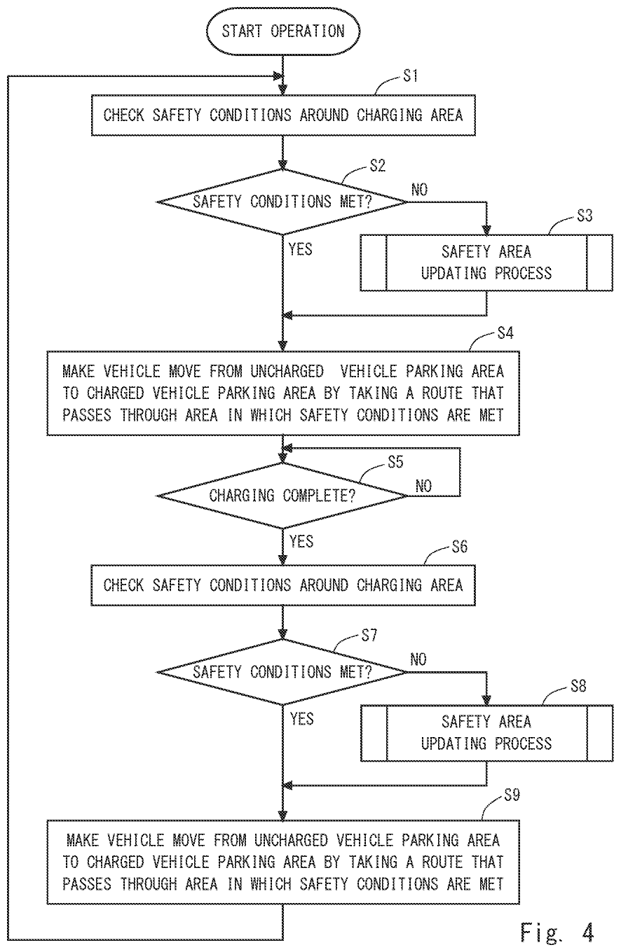

FIG. 4 shows a flowchart for explaining operations of the charging system 1 according to the first embodiment. As shown in FIG. 4, in the charging system 1 according to the first embodiment, the charge port operation arm control unit 25 checks the state of the charging cable around the charging area in light of the safety conditions using the state monitoring sensor 12 (Step S 1). Specifically, determination of the safety conditions of the state of the charging cable in Step S1 is performed by determining the safety conditions of the state of the charging cable over the range of the areas including the charging area. Further, as for the safety conditions of the state of the charging cable in Step S1, for example, a state shown in FIG. 3 in which the charging cable has not been removed from inside any one of the parking sections B1 to B5 for charging in the charging area is regarded as a state in which the state of the charging cable does not meet the safety conditions.

Next, in the charging system 1 according to the first embodiment, whether or not the state of the charging cable meets checked in Step S1 meets the predetermined safety conditions is determined by the charge port operation arm control unit 25 (Step S2). In Step S2, when it is determined that the state of the charging cable meets the safety conditions, the process proceeds to Step S4 of making the vehicle travel, whereas when it is determined that the state of the charging cable does not meet the safety conditions, the process proceeds to a step (Step S3) of updating the area in which the charging cable meets the safety conditions (hereinafter referred to as the safe area updating process) is performed. Details of the safe area updating process (Step S3) will be described later.

In Step S4, the vehicle position control unit 24 makes the vehicle travel from the uncharged vehicle parking area to the charged vehicle parking area by taking a route that passes through the area in which the safety conditions are met. Then, after the charging is complete (YES in Step S5), the charging system 1 performs processes for making the charging cable meet the safety conditions in Steps S6, S7, and S8 by repeating the same processes of Steps S1 to S3. Then, the charging system 1 makes the vehicle travel from the charging area to the charged vehicle parking area by taking a route that passes through the area in which the safety conditions are met (Step S9). The charging system 1 according to the first embodiment performs the aforementioned processes of S1 to S9 for every vehicle.

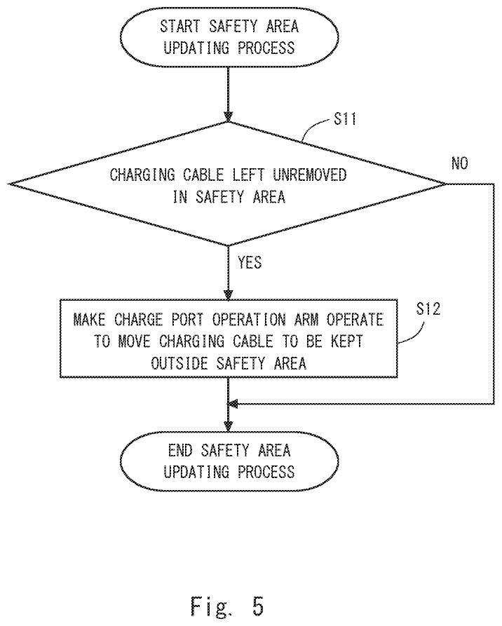

Here, the safe area updating process according to the first embodiment performed in Steps S3 and S8 will be described in detail. FIG. 5 shows a flowchart for explaining the safe area updating process of the charging system according to the first embodiment. In the safe area updating process according to the first embodiment, the charge port operation arm control unit 25 determines, based on the information obtained using the state monitoring sensor 12, whether or not a cable has not been removed from inside the areas designated as the safe area such as the parking sections for charging in the charging area and the aisles that are formed around the charging area (Step S11).

In Step S11, when it is determined that a charging cable has not been removed from inside the safe area, the charge port operation arm control unit 25 makes the charge port operation arm A1 operate to remove the charging cable so that the charging cable is removed from inside the areas designated as the safe area such as the aisles through which the vehicles travel and the parking area (Step S12).

As described above, in the charging system 1 according to the first embodiment, the management apparatus 10 moves, using the charge port operation arms A1 to Am, the charging cable so that a state in which the charging cable has not been removed from inside the areas designated as the safe area such as the aisles through which the vehicles travel and the parking area is avoided,. Accordingly, it is possible to avoid a state in which safety in performing charging of vehicles cannot be ensured at a satisfactory level such as the charging cable that has not been removed from inside the safe area is driven over by a vehicle that has entered the safe area or the charging cable gets tangled with the vehicle that has entered the safe area.

Further, in the charging system 1 according to the first embodiment, the charge port operation arm grasp the charging cable to be used and inserts the charging plug provided at the tip of the charging cable into the charge port of the vehicle. By this configuration, in the charging system 1 according to the first embodiment, the degree of freedom of operability of the charging cable can be enhanced. To be more specific, in the charging system 1 according to the first embodiment, even when a part of the charging cable has not been removed from inside an area serving as the safe area in which safety should be ensured, the charging cable that has not been removed from inside such an area can be removed in a relatively short time.

### Second Embodiment

In a second embodiment, an embodiment of the safe area updating process different from that of the first embodiment will be described. Specifically, in the safe area updating process according to the second embodiment, the control unit (e.g. the management apparatus 10) changes, based on the range of the area in which the charging cable is present, the range of the area in which the safety conditions of restricting the next incoming vehicle from entering the area are not met. To be more specific, in the safe area updating process according to the second embodiment, the processes for updating the safe area are performed by the vehicle position control unit 24 using the state monitoring sensor 12.

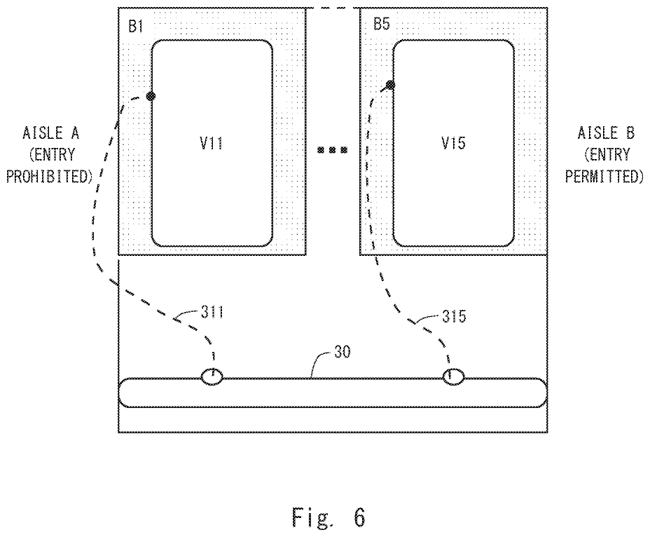

Firstly, the state in which the state of the charging cable does not meet the safety conditions, which is a case covered in the second embodiment, will be described. FIG. 6 shows a diagram for explaining an example of a state in which the state of the charging cable does not meet the safety conditions in the parking area of the charging system according to the second embodiment. In the example shown in FIG. 6, the charging cable 311 is connected to the vehicle V11 parked in the parking section B1 for charging and a part of the charging cable is protruding into the aisle A formed around the charging area. In such a situation, it is effective to perform the safe area updating process according to the second embodiment. Taking charging of the vehicle V11 as an example, since it is difficult to move the charging cable 311 in the aforementioned situation, it is better to temporarily prohibit entry of another vehicle into the aisle A so that the overall time for fully charging the vehicle V11 can be saved.

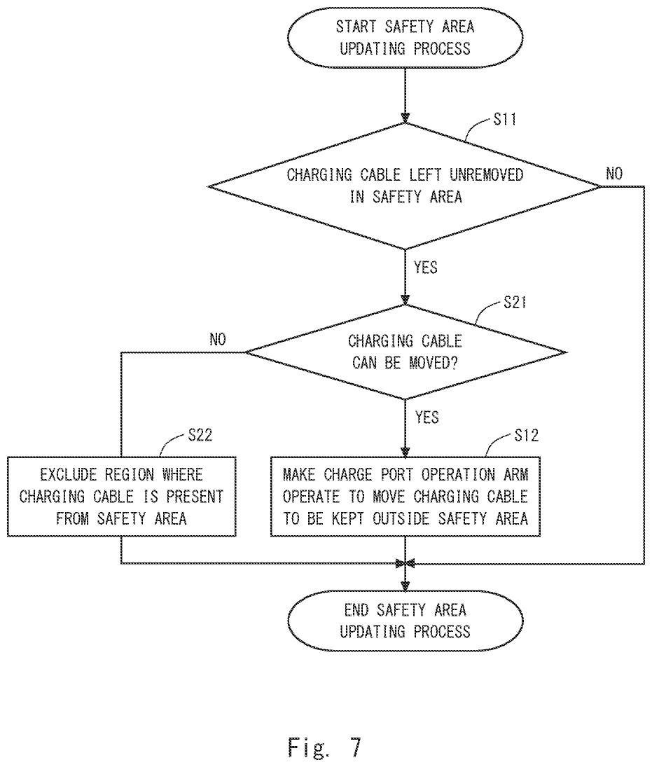

Next, the safe area updating process according to the second embodiment will be described in detail. FIG. 7 shows a flowchart for explaining safe area updating process of the charging system according to the second embodiment. In the flowchart shown in FIG. 7, the safe area updating process according to the second embodiment includes processes of Steps S21 and S22 of performing the safe area updating process according to the second embodiment in addition to the processes Steps S11 and S12 of the safe area updating process according the first embodiment, but Step S22 need not be performed.

In the safe area updating process according to the second embodiment, the vehicle position control unit 24 determines, based on the information obtained using the state monitoring sensor 12, whether or not a cable has not been removed from inside the parking section for charging in the charging area designated as the safe area or in the aisles that are formed in the area around the charging area (Step S11).

Then, in Step S11, when it is determined that a charging cable has not been removed from inside the safe area, the vehicle control unit 24 and the charge port operation arm control unit 25 determine whether or not the charging cable can be moved (Step S21). In Step S21, when it is determined that the charging cable can be moved, the charge port operation arm control unit 25 makes the charge port operation arm A1 operate to remove the charging cable so that the charging cable is removed from inside the areas designated as the safe area such as the aisles through which the vehicles travel and the parking area (Step S12).

On the other hand, when it is determined in Step S21 that the charging cable cannot be moved, the vehicle position control unit 24 performs the process of excluding the region where the charging cable is present (e.g. the aisle A in FIG. 6) from the safe area (Step S22).

In the safe area updating process according to the second embodiment, even in a state in which it is difficult to move the charging cable, safety area in which safety of vehicle traffic can be ensured can be managed appropriately, and safety of the whole system can be improved.

### Third Embodiment

In a third embodiment, another embodiment of the safe area updating process will be described. Specifically, in the safe area updating process according to the third embodiment, the control unit (e.g. the management apparatus 10) restricts a next incoming vehicle from parking in the parking section for charging in the charging area that is within the range of the area in which the state of the charging cable is one that does not meet the updated safety conditions in the case where the range of the area determined to be an area in which the state of the charging cable is one that does not meet the updated safety conditions overlaps the parking section for charging in the charging area in which the next incoming vehicle is to be parked. To be more specific, in the safe area updating process according to the third embodiment, the processes for updating the safe area are performed by the vehicle position control unit 24 using the state monitoring sensor 12.

That is, in the safe area updating process according to the third embodiment, next incoming vehicle is restricted from parking in the parking section B2 for charging in the state shown in FIG. 3.

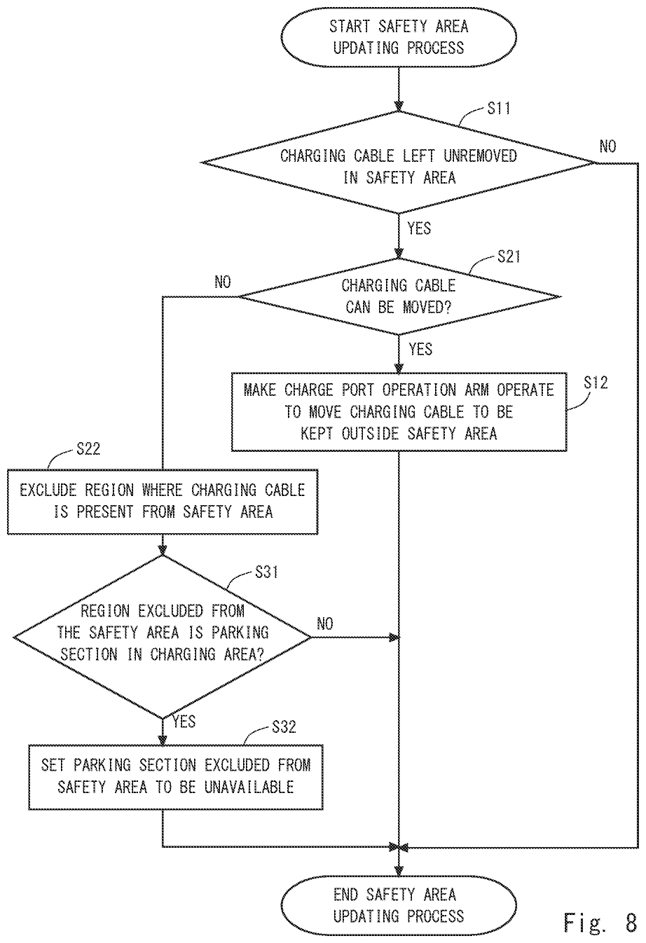

Here, the safe area updating process according to the third embodiment will be described. FIG. 8 shows a flowchart for explaining the safe area updating process of the charging system according to the third embodiment. As shown in FIG. 8, the safe area updating process according to the third embodiment is performed by carrying out Step S31 and Step S32 after Step S22 of the safe area updating process according to the second embodiment. Step S31 and Step S32 are processes performed by the vehicle position control unit 24.

In Step S31, whether or not the region excluded from the safe area in Step S22 is the parking section for charging in the charging area is determined. Then, when it is determined that the region excluded from the safe area in Step S31 is the parking section for charging in the charging area, the vehicle position control unit 24 sets the parking section for charging in the charging area excluded from the safe area to be unavailable (Step S32), and moves the vehicle so that that charging of the vehicle is performed in a section other than the section that is excluded from the safe area. Note that it is desirable to also notify the charging schedule management unit 23 that use of the parking section for charging in the charging area is prohibited and to change the charging schedule.

As described above, in the safe area updating process according to the third embodiment, it is possible to perform charging smoothly as a whole while ensuring safety of charging in the parking section for charging in the charging area.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A charging system comprising:
an arm mechanism configured to grasp a charging plug connected to a charging apparatus through a charging cable and automatically perform plugging/unplugging of the charging plug to and from a charge port of a vehicle located at a charging area;
a sensor configured to detect whether or not a state of the charging cable meets predetermined safety conditions when the charging plug is inserted into the charge port of the vehicle; and
a control unit configured to perform, in a case where it is detected that the charging cable is in a state in which it does not meet the predetermined safety conditions, at least one of a process of making the arm mechanism operate to move the charging cable so that the state of the charging cable becomes one in which the predetermined safety conditions are met or a process of updating the predetermined safety conditions based on the state of the charging cable.

2. The charging system according to claim 1, wherein the control unit instructs the arm mechanism to perform a predetermined recovery operation so that the state of the charging cable becomes one in which the predetermined safety conditions are met.

3. The charging system according to claim 1, wherein the control unit updates the predetermined safety conditions such that an area in which the charging cable is present falls within an area in which the state of the charging cable does not meet the updated predetermined safety conditions, and restricts a next incoming vehicle from entering the area in which the state of the charging cable does not meet the updated predetermined safety conditions.

4. The charging system according to claim 3, wherein in the case where the area in which the state of the charging cable does not meet the updated predetermined safety conditions overlaps a parking section for charging, the control unit restricts the next incoming vehicle from parking in the parking section for charging that is in the area in which the state of the charging cable does not meet the updated predetermined safety conditions.

5. The charging system according to claim 1, wherein the sensor is a camera that captures an image of a region including the charging area.

6. The charging system according to claim 1, wherein conditions for the state of the charging cable to meet the updated safety conditions include at least a state in which the charging cable is removed from inside an empty parking section for charging among a plurality of parking sections for charging set in the charging area and a state in which the charging cable is not protruding into a region outside of the charging area.

7. A non-transitory computer readable medium storing a safety management program for causing a control unit of a charging system, which comprises an arm mechanism configured to grasp a charging plug connected to a charging apparatus through a charging cable and automatically perform plugging/unplugging of the charging plug to and from a charge port of a vehicle located at a charging area, to perform:
a process of detecting, using information obtained from a sensor connected to the charging system, whether or not a state of the charging cable meets predetermined safety conditions when the charging plug is inserted into the charge port of the vehicle; and
in a case where it is detected that the state of the charging cable does not meet the predetermined safety conditions, at least one of a process of making the arm mechanism operate to move the charging cable so that the state of the charging cable becomes one in which the predetermined safety conditions are met or a process of updating the predetermined safety conditions based on the state of the charging cable.

8. A safety management method for a charging system that comprises an arm mechanism configured to grasp a charging plug connected to a charging apparatus through a charging cable and automatically perform plugging/unplugging of the charging plug to and from a charge port of a vehicle located at a charging area, the method comprising:
detecting, using information obtained from a sensor connected to the charging system, whether or not a state of the charging cable meets predetermined safety conditions when the charging plug is inserted into the charge port of the vehicle; and
performing, in a case where it is detected that the state of the charging cable does not meet the predetermined safety conditions, at least one of a process of making the arm mechanism operate to move the charging cable so that the state of the charging cable becomes one in which the predetermined safety conditions are met or a process of updating the predetermined safety conditions based on the state of the charging cable.
